(19) United States
(12) Patent Application Publication
(10) Pub. No.: US 2009/0277433 A1
(43) Pub. Date: Nov. 12, 2009

(54) SMALLEST, HIGHEST ENERGY DENSITY INDUCTIVE COILS WITH OPTIMIZED EQUATION FOR RARE EARTH HIGHEST ENERGY BIASING MAGNETS

(76) Inventor: Michael A.V. Ward, Lexington, MA (US)

Correspondence Address: BURNS & LEVINSON, LLP, 125 SUMMER STREET, BOSTON, MA, 02110, US

(21) Appl. No.: 12/434,148

(22) Filed: May 1, 2009

Related U.S. Application Data
(60) Provisional application No. 61/126,677, filed on May 6, 2008.
(60) Provisional application No. 61/131,586, filed on Jun. 10, 2008.

(51) Int. Cl. F02P 3/02; H01F 38/12

(52) U.S. Cl. 123/634

(57) ABSTRACT

An ignition-engine system for internal combustion engines having two-valves [46, 47] in the cylinder head and an Optimized Coil [9] per plug [20], the optimized coil being a small coil of peak primary current Ip of approximately 20 amps, spark current Is of approximately 350 ma, spark energy Ep is about 160 mJ, a secondary turns Ns to primary turns Np ratio, where Nt=Ns/Np, is approximately 50, and a primary turns Np is approximately 90, and two biasing magnets at the open end of the coil of an open-E coil which are optimized and disclosed to produce the highest ignition coil energy density.

This application claims priority under USC 119(e) of U.S. provisional applications Ser. No. 61/126,677, filed May 6, 2008, and Ser. No. 61/131,586, filed Jun. 10, 2008.

### FIELD OF THE INVENTION

This invention relates to ignition systems for spark ignition internal combustion (IC) engines which have a high energy density inductive ignition coils of energy up to about 180 millijoules (mj) and about 40 kilovolts and spark currents of 200 to 500 milliamps (ma), as applied to lean burn high efficiency engines with high squish flow in the region of ignition.

### BACKGROUND OF THE INVENTION AND PRIOR ART

The invention relates to high energy, flow-coupling, coil-per-plug inductive ignition systems with high energy density coils (>1.0 mj/gm), operating at higher voltage and current, for use more ideally with internal combustion engines which produce high flow at the spark plug site(s) during ignition. The invention particularly relates to a 42 volt based coil-per-plug inductive ignition system as disclosed in my U.S. Pat. No. 6,142,130, referred to henceforth as '130, having a high energy density coils of about 150 mj and high spark currents in the 200 to 600 ma range; and have a pair of biasing magnets in the open end of the E-core, as has been disclosed, in part, in my U.S. Pat. No. 7,178,513, referred to henceforth as '513, and in my U.S. Pat. No. 7,182,077, referred to henceforth as '077. The invention also relates to both four-stroke and two-stroke, uniflow-scavenged, engines, with two plugs per cylinder with high energy density coils (optimized coils), preferably directly mounted on the plugs and on the cylinder head, preferably using improved halo-disc plug shown in patent '513 and in patent application Ser. No. 12/319,982, referred to henceforth as '982. The Ford PROCO engine (SAE paper 780699) also uses two plugs. The patents and patent applications are incorporated herein as though set out at length herein.

### SUMMARY AND OBJECTS OF THE INVENTION

A principle object of the present invention is to develop a small coil of peak primary current Ip of approximately 20 amps, i.e. 15 and 25 amps, spark current Is of 200 to 600 ma, spark energy Ep is 80 to 300 mJ, a secondary turns Ns to primary turns Np ratio, where Nt=Ns/Np, is between 30 and 60, and a primary turns Np between 60 and 140, and two biasing magnets which are optimized and disclosed to produce the highest ignition coil energy density.

The term “approximately”, or “approximately equal to” as used throughout this specification means within plus or minus 25% of the value it qualifies. The term “equal to” means plus or minus 12% of the value it qualifies, unless otherwise stated; and the term “about” means between 0.5 and 2 times the term it qualifies.

It is an aspect of the invention to have a high energy density and high efficiency inductive ignition Coil of the ignition system disclosed in '130, '513, '077 which are achieved by the use of biasing magnets located at the open end of the coil to raise the coil energy density to over 1.0 mJ/gm and raise the coil efficiency. A novel precise mathematical equation, the Optimization Equation, uses biasing magnets optimized for a coil winding structure which allows for the smallest, highest energy coil of 80 to 300 mJ or higher, with secondary spark current preferably of approximately 350 ma, i.e. predominantly in the high glow and low arc discharge mode. The coil is small, and light enough, to be directly mounted on the spark plugs or near the plugs.

Another aspect of the invention uses a Optimization Equation developed by me for the precise, optimized, highest energy density coil, in terms of the energy stored in the biasing magnets Emag and the volume Vmag of the biasing magnets, which are precisely selected given the core volume V and peak flux density B, the primary turns Np, the turns ratio Nt, the primary inductance Lp, etc., to obtain a precisely optimized, highest energy density coil. Note that the coil has a low turns ratio Nt even below 50 despite a high peak coil output voltage Vs(max) of 40 kilovolts for a given high energy and high peak primary voltage Vp(max), e.g. using an industrial 600 volt rated Insulated Gate Bipolar Transistor switch, or IGBT.

Another aspect of the invention is that as part of the definition of the complete ignition system, the value of secondary capacitance of the coil Csc and of the plug Csplug is specified. For a typical car ignition coil with segmented, low capacitance secondary winding of about 20 picofarads (pF) and stored coil energy of 200 mj, allows for a low turns ratio Nt of the coil of equal to 48 for output voltage equal to 41 kV for 600 volts peak primary voltage using a 600 volt IGBT, instead of higher Nt of approximately 90 for a voltage equal to 40 kV as is found for typical low energy 50 mj coil using an approximately 400 volt rated switch,

Another aspect of the invention is to preferably use elongated ET-⅜-LP laminated core of M6 material made by Thomas & Skinner (T & S) with a width of the laminations equal to 1.375″, the center leg width equal to 0.32″ and side legs equal to 0.16″, a wider winding windows of equal to 0.37″, and window length equal to 1.5″ for winding the primary and secondary wire and containing the biasing magnets, with typically 22 to 26 AWG (American Wire Gauge) primary wire of approximately 90 turns Np, and turns ratio Ns/Np (Nt) equal to 48 turns ratio for a typical car ignition with a peak of approximately 40 kV. Secondary winding wire is of 36 to 40 AWG wire, and is approximately of 4,500 turns of wire Ns. The primary inductance of the coil Lp is between 0.8 and 1.2 mH. Biasing magnets are placed at the open ends of the laminations completing the magnetic path, the size of the biasing magnets being precisely and optimally specified. The open ends may be placed at either the low voltage or high voltage end, with the biasing magnets located in the open ends. The design resembles a closed E-core.

Another aspect of the invention is the optimized design of a pencil coil of length equal to 2.3 inches, diameter equal to 1.0 inch, center leg equal to 0.35″, the outer tube having a thickness equal to 0.06 inch, and a window length equal to 1.6″ for winding the primary (and secondary wire) with typically 22 to 26 AWG primary wire of approximately 100 turns Np, and turns ratio Ns/Np equal to 46 turns ratio for a car ignition with a peak of approximately 40 kV. Secondary winding wire is 36 to 40 AWG wire and is approximately of 4,600 turns of wire Ns. The primary inductance of the coil Lp is between 0.8 and 1.2 mH. Biasing magnets are placed at one end of the open ends of the laminations, the size of the biasing magnets being optimally specified. At the other end is preferably placed a ferrite cylinder to make a closed magnetic path.

Another aspect of the invention is that as part of the definition of the complete ignition system, the value of secondary capacitance of the coil Csc and of the plug Csplug is specified. For a typical car ignition coil with segmented, low capacitance secondary winding of about 20 picofarads and stored coil energy of 180 mj, allows for a low turns ratio Nt of the coil of equal to 50 for output voltage approximately 40 kV for 600 volts peak primary voltage using a 600/volt IGBT, instead of higher Nt of approximately 100 for a voltage equal to 40 kV as is found for typical low energy 50 mj coil using an approximately 400 volt rated switch.

Another aspect of the invention is to have the coil directly mountable on the plugs and on the cylinder head, preferably on halo-disc spark plugs.

Another aspect of the invention is that the spark plug is of the halo-disc type disclosed in my U.S. Pat. No. 5,577,471, '513 and '077, and preferably has concave instead of typical convex type insulator end, which at one atmosphere and a spark gap of 0.070″ has a low breakdown voltage of approximately 7 kilovolts (kV), versus a standard J-type plug with a similar gap which has a breakdown voltage of approximately 10 kV. The plug is a slim line plug with the smaller size ⅝ or 9/16 hex, and has erosion resistant material at the electrode ends, such as Nickel-200 on the ground side and tungsten-nickel-iron (W—Ni—Fe) on the HV tip.

Another aspect of the invention is to have a two-stroke, uniflow-type scavenged cylinder head with two similar exhaust valves and two symmetrically placed spark. plugs at right angles to the valves, and a fuel injector located in the center of the head able to inject fuel via electronic control multi-times in a firing cycle, with optimized-coils mounted on the plugs, wherein the valves are closed for about 120° after TC, open for about the next 120° along with the air intake for about the same period, and the exhaust valves closed for about 120° before TC.

Another aspect of the invention is to have a two-stroke, uniflow-type scavenged cylinder head with two exhaust valves and two spark plugs placed at right angles to the valves, and a fuel injector located in the center of the head, and two squish-lands placed on the two sides of the valves to provide a channel near TC for the mixture to flow along, and the squish-lands to create ignition flow-coupling with the two plugs, and intake ports with reed valves or check valves to prevent higher pressure exhaust gas from entering the fresh charge.

Other features and objects of the invention will be apparent from the following drawings of preferred embodiments of the invention taken with the accompanying drawings, in which:

### BRIEF DESCRIPTION OF THE DRAWINGS

FIG. 1 is a twice scale, side view of a preferred embodiment of compact, open E-type ignition coil with two biasing magnets at the open ends, designed according to the Optimized Equation, and based on the EI-⅜-LP Thomas & Skinner, M6 Silicon-Iron (Si—Fe) lamination.

FIG. 1a is an approximately to scale, partial side-view drawing of a slim line plug, mounted on a cylinder head, and on top of the plug is shown a small, high energy density optimized coil.

FIG. 2 is a twice scale side view and FIG. 2a, 2b are top views of a preferred embodiment of a compact pencil coil with two biasing magnets at one end designed according to the Optimized Equation and a ferrite cylinder at the other end between the center and outer magnetic core section.

FIG. 3 is an approximately twice scale, side-view of a capacitive, halo-disc plug having a slim-line body with a ⅝″ hex.

FIG. 4a is an approximately to scale, top view drawing of a single cylinder, two-stroke uniflow-scavenged with two plugs symmetrical placed with small, high energy density optimized coils mounted on the plugs, and between the plugs and approximately located at the center of the head fuel-injector means, and two vertically oriented valves equally spaced about the center of the head. Preferably, two squish-flow lands are shown on the top and bottom halves of the cylinder, so that when the piston is near or at top center (TC) a channel is formed.

FIG. 4b is an approximately to scale, side view drawing of a single cylinder, two-stroke uniflow-scavenged with two plugs with small, high energy density optimized coils mounted on the plugs, and between the plugs and approximately located at the center of the head fuel-injector means with two vertically oriented valves equally spaced about the center of the head, with the piston at about 120° before TC and the exhaust valves having just closed, and the fuel injector giving the main fuel injection spray, which mixes with the mostly fresh air, to form a partial homogeneous mixture at TC (120° later).

### DISCLOSURE OF PREFERRED EMBODIMENTS

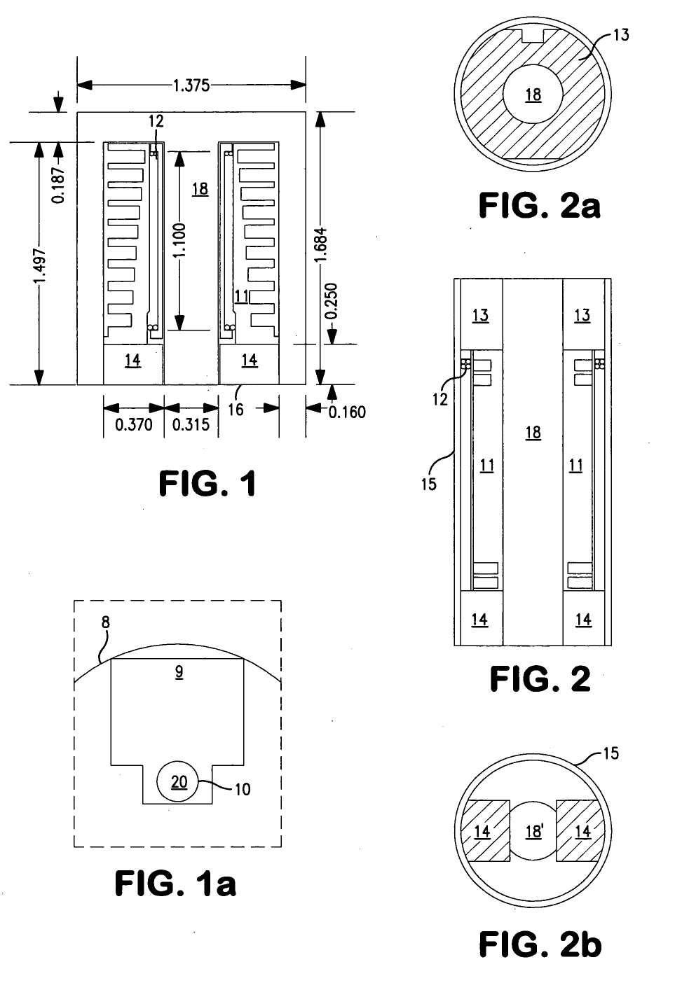

In the preferred embodiment the present invention, the primary winding is located on the inside, and the secondary winding is located on the outside, in the preferred form of axially segmented windings of 7 to 12 bays, with turns ratio Nt between 30 and 60 for a preferred approximately 40 kV peak output voltage, i.e. 30 kV to 50 kV. The primary inductance Lp of the coil is approximately 1,000 microhenry (uH), i.e. 750 and 1,250 uH, for the present coil high energy of approximately 200 mJ, i.e. 150 mJ to 250 mJ, with round wire used for the primary wire of typically 22 to 27 AWG (American Wire Gauge). The above parameters are suitable for an energy optimized coil based on an elongated EI-⅜-LP Thomas & Skinner (T&S) laminated core with wider windows, as shown if FIG. 1. The winding length lw is shown in FIG. 1 to be 1.25″ (1.50″-0.25″) which is available for the secondary bobbin 11, and lp is shown equal to 1.1 inch, where it will be shown that the optimized height of the biasing magnet will be 0.26″.

In a preferred embodiment, in FIG. 1, is shown a secondary bobbin 11 with 9 bays for low capacitance, and a secondary length lw of 1.25 inch, and a winding length for the primary wire 12 is also equal to 1.1 inch to minimize the leakage inductance Lpe. The primary winding will be made up of simple round magnet wire, and in this figure is equal to 87 turns of heavy insulated wire. Obviously, by adjusting the thickness of insulation, and/or the gauge of the wire, e.g. 22.5 or 23.5 AWG, one can adjust the number of turns, i.e. 82 to 94.

The bias magnets 14 will be placed at the open ends 16 of the laminations, and will be of length to fit the gap between the center and end laminations (0.37″ in FIG. 1), of width 0.32″, i.e. approximately the same width as the center leg square 18. In this embodiment, the secondary winding has thicker flanges in the bays of the higher voltages. In the present secondary winding, there are nine bays which preferably have approximately 4,300 of 38 AWG heavy insulation build, with decreasing number of turns from the low voltage end to the high voltage end, e.g. 615, 585, 555, 525, 495, 465, 405, 345, 285, for a total of 4,275 where generally the clearance to the primary winding and the side laminations increases as the voltage increases.

I can now disclose my optimization method for the coil of FIG. 1, understanding that the biasing magnets are preferably NdFeB biasing magnets of energy density Emagden=320 mJ/cm³, which is a typical value. Conforming to the coil of FIG. 1 and judiciously picking other values:

A=0.95*0.315**2=0.094 in²=0.60 cm² is the core area.

Np=87, Ip=1.1″, with single magnet wire winding of 23 AWG

Length of laminations=0.19+1.5=1.69 in Width of laminations=1.375 in

Other dimensions of laminations=0.315, 2*0.16, 0.37 inches

Lp=1.0 mH is estimated as the primary inductance of the coil.

Bsat=[10*Ip1]/[87*0.6]=0.19*Ip1=2.0 Tesla, is the saturation flux density of the core material, which is preferably SiFe of type M6.

Ip1=10.5 amp is the required current to give 2.0 Tesla.

Ep1=½*Lp*[10.5]**2=0.5*110 55 mJ is the energy stored in the coil without and biasing magnets.

Making a best guess of the biasing magnet volume Vmag=ml*mw*ht, expressed in cm³.

Vmag=[0.37]*[0.32]*[0.25]*16.4 cm³ where the height “ht” is picked at 0.25″,=0.485 cm³ is the volume of each magnet.

V_{1/2}=A*11, and the effective length of the core is equal to the actual length Lcore minus the width of the outer leg, i.e. in this case equals Lcore−w/2=1.69−0.16=1.53,

V_{1/2}=A*[1.53+T]*2.54

where “T” is the average end pieces of the lamination and magnet, which is the length dimension “ml” times the average height of the magnet and the end piece of the lamination, i.e. in this case equals T=√1.4*ml=1.2*0.37=0.45″

V_{1/2}=0.6*[1.53+0.45]*2.54=0.6*5.0=3.0 cm

Emag=Vmag*Emagden=0.485*320=155 mJ

is the stored energy in each half of the biasing magnet.

Ep11=155/3.0=52 mJ is the average magnetic energy stored in each half core.

Ep11=½*Lp*[Ip11]**2=0.5*[Ip11]**2=52 mJ

Ip11=√104=10.2 amps is the equivalent current to give a stored energy of 52 mJ.

The total current swing to exactly cancel the magnetic bias, i.e. Ip11=10.2 amps, and then to produce a magnetic flux of 2.0 Tesla, i.e. Ip1=10.5, gives a total current Ip2, i.e.

Ip2=Ip11+Ip1=10.2+10.5=20.7 amps which gives a total energy Ep2, i.e.

Ep2=½*1.0*[20.7]**2=0.50*428=214 mJ

The magnetic energy needed to produce an optimized coil is the added bias magnet height “ht” that must be calculated according to the “Optimization Equation” which I have derived with use of the following terms, among others. Recalling the following relations,

Vmag=ml·mw·ht=0.485 cm³*(ht/0.25″), is one way of expressing it.

V½=A·11=3.0 from above

Emag=Vmag·Emagden

Ep11=Emag/V½

Ep1=½·[Bsat·Np·A]²/100·Lp=Emag/V½

½·V½·[Bsat·Np·A]²=Emag·100·Lp=Vmag·Emagden·100·Lp

½·11·[Bsat·Np]²·A³=ml·mw·ht·Emagden·100·Lp

ht={½·5.0·[2·87]²·0.6³}/{0.37·0.32·6.45·320·100}

ht==16,350/24,438=0.67 cm=0.264 inches

and the Optimized Equation asserts that the biasing magnets should be 0.264″, or 0.014″ higher than the value of 0.25″ that we selected.

It is noted that the optimized coil energy is four times as high with the addition of the optimized biasing magnets, i.e. Ep22=220 mJ is exactly four times as great Ep1=55 mJ. Also, a larger core, the larger T&S, EI-½-LP was used for high energy, e.g. 160 mJ, since the T&S, EI-⅜-LP core was not thought possible prior to the present formulation and disclosure, i.e. it was thought as too small. Also, the complexity of a bifilar primary winding is not necessary.

Below is the calculation for the peak output voltage for the optimized coil,

Cs=60 pF, and Ccoil=20 pF, Cplug=40 pF

Ip=20.8 amps

E_{Lpe}=½*Lpe*[Ip]²=½*50*[20.8]²*10⁻⁶=25*0.433 mJ=11 mJ are the leakage losses, and Esw are the switching losses of the IGBT.

Esw=15 mJ

Epo=½*Lp*[Ip]**2=0.50*[20]**2=200 mJ

Ep=Epo−[Esw+E_{Lpe}+Eother]=Epo−Etrans=200 mJ−40 mJ=160 mJ

where Eother are an estimate of other losses (assumed 14 mJ), and Etrans is the energy lost in having the energy stored in the primary winding be transferred to the secondary winding, the principle losses be the coil leakage losses (E_{Lpe}) and the switching losses (Esw).

That the maximum optimized energy is given by Ep2 (214 mJ) and the primary current is given by Ip2 (20.8 amp), i.e. it is equal to the theoretical values contained in the coil during primary charging. In order to stay away from saturation and high losses, we pick a value lower than Ep2, e.g. Ipo=20 amps and Epo=200 mJ. Then, the energy available to the secondary circuit is Ep, subtracting out the transfer losses (Etrans), as shown above.

Vso=41,000 volts assumed

Es=½*Cs*Vs²=30*[10**−12]*[41,000]**2=0.3*0.168 J=50 mJ

Nt=48 assumed, which gives a secondary turns of 4,176 (Np=87), and it can be shown that the secondary peak current Is is 18/48=375 ma.

Vp=560 volts is the peak clamped voltage of the IGBT on being turned off Using the equation disclosed in my patent '077, we have

Vs={2/[1+Es/Ep]}*Nt*Vp={2/[1+50/160]}*48*560={2/1.31}*26,880=41 kilovolts, which is also a verification that Vso was properly selected.

FIG. 1a is an approximately to scale, partial side-view drawing of a slim line spark plug 20, mounted on a partial drawing of a cylinder head 8, and on top of the plug is shown a small, high energy density optimized coil 9.

The body of the coil 9 can be preferably that shown in FIG. 1, and the flexible section 10 is for mounting on the plug 20 and on the cylinder head 8.

While the above disclosure for choosing the size of the biasing magnet is shown with respect to a square or rectangular core, it equally well can be applied to a pencil type coil of diameter equal to near one inch and of length of approximately 2.3 inch.

In FIG. 2, assuming that the center of the core 18 is of a 0.34″ diameter, and is an essentially round cylindrical SiFe laminated core (made up of thin SiFe strips of different widths), followed by a cylindrical, secondary segmented bobbin 11 surrounding and containing the cylindrical core with an approximately 0.18″ width bobbin (total OD of 0.34″+0.18+0.18=0.70″), surrounded by a 23 AWG primary wire 12 mounted an a simple bobbin (thickness of bobbin 0.03″ and two wires 0.05″), for overall diameter of coil is 0.70″+2*0.08″, which equals 0.86″. The outer return for the core is 2.25″ long and 0.05″ thickness 15, giving the pencil coil dimensions of 2.25″ long by 0.96″ diameter. It will be shown that two magnets 14, of proper size, placed at one end of the coil between the center core 18 and the outer return core 15, to give an optimized, maximum energy density.

In FIG. 2a, at the other end, a ferrite or other magnetic material 13 is placed to close the magnetic path of the coil. The biasing magnets and the terminal or end-ferrite are preferably in contact with the inner and outer magnetic cores for achieving and contributing to the coil optimization. That is, the method of obtaining optimization of the coil requires that preferably the biasing magnets be in good contact with the (SiFe) magnetic material so that the flux lines are contained in the magnetic material and not fringing into the air.

In FIG. 2b, note that the center core will be somewhat flat 18′ at the two opposite sides where it is not practical to have lamination strips less that about 0.1″, so that the inner sides of the biasing magnets 14 may be flat while the our sections will be rounded to conform to the outer return thin core. Note that the energy density of the optimized coils are higher than that has been obtained to date, i.e. well over 1 mJ/gm. The optimization in the analysis that follows is selected with the optimum dimensions which are given below.

A=0.90*0.17**2*3.14=0.082 in²=0.53 cm², where the factor of 0.90 is taken because the laminated strips making up the cylinder are at best 90% of the fill factor.

Np=100, Nt=46, Ip=1.30″ single winding, 23 AWG, OD=0.025″

A1=3.14*0.34*Lfer=1.07*Lfer=5*A=5*0.082 in², for an assumed ferrite end piece, i.e. ⅕ the magnetic saturation of SiFe. Hence, it needs to have 5 times the area, i.e.

Lfer=0.38 inch

The NdFeB biasing magnet has a maximum operating temperature of 150° C., and the type of ferrite or other magnetic material can have higher operating temperatures, the preferable position of the ferrite is the high voltage end since it is closer to the hotter spark plug.

The dimensions of two biasing magnets is 0.27″ length, 0.34″ width, 0.36″ height.

Secondary bobbin=lp+0.20″=1.30″+0.20″=1.50″

Length of laminations=1.50″+0.38″+0.37″2.25″

Diameter of pencil coil≈0.96 in

Lp is a best guess at 1.1 mH

Bsat[11*Ip1]/[100*0.53]=0.208*Ip1=2.0 Tesla

Ip1=9.6 amp

Ep1=½*Lp*[9.6]**2=0.55*93=51 mJ

Vmag=[0.27*2.54]*[0.34*2.54]*[0.36*2.54] cm³0.033*16.4 cm³=0.54 cm³

V_{1/2}A*[2.0+0.5]*2.54=0.53*2.5*2.54 cm=3.37 cm³

Emag=0.54*320=173 mJ

Ep11=173/3.37=51 mJ, and Ep11 is equal to Ep1, the optimization criterion.

Ip2=Ip11+Ip1=2*Ip1=19.2 amps

Ep2=½*1.1*[19.2]**2=0.55*369≈203 mJ

Subtracting out the correction factor Etrans, assumed equal to 43 mJ, we are left with Epo, the energy that is available to the secondary circuit.

Epo=160 mJ

Epo=160 mJ=½*Lp*[Ip3**2]=0.55*[Ip3**2]

Ip3 =√291=17 amps

Is3=17/46=370 ma for Nt=46, Ns=4,600 of about 40 AWG wire.

Following the previous example, we can expect the peak output voltage to be 40 kV, i.e.

Vs={2/[1+Es/Ep]}*Nt*Vp={2/[1+48/160]}*46*560={2/1.30}*25,760=40 kilovolts

Note that the secondary winding was on the inside of the primary winding. Obviously, the two windings can be reversed, i.e. primary winding on the inside. It is noted that there was a certain choice made in some of the parameters, while the optimization technique is a rigorous mathematical formulation disclosed. With practice, since the energy densities of the coils are much higher, better selection of the non-critical components will be made with practice.

If instead of the round primary wire, a slightly elongated wire is used so that, for example, the ten bays of 0.08″ wide bays are replaced with 0.09″ wide bays (using 38-39 AWG wire instead of 39-40 AWG wire), then the length of the pencil coil is increased from 2.25 to 2.35 inches, and the thickness of the elongated wire is reduced from 0.025 to 0.020 inches, then the diameter of the pencil coil is reduced from 0.96 to 0.94 inches. Or if elongated 24 AWG is used with thickness of 0.015, then the diameter of the coil is 0.92 inches, the smallest diameter with several times the energy density of an automotive coil.

It can be concluded that a rigorous analysis made by me of an optimized coil with two biasing magnets, preferably high energy density NdFeB which has twice the energy density of high temperature SmCo, the net result is to allow for the design of a open-E type core or pencil coil with a smaller size and higher energy density than was thought possible. The upper limit was considered to be 1 mJ/gm, and the limit is now over 1 mJ/gm, i.e. 1.3 mj/gm, or higher. Note that while in this analysis there was no limitations of the power supply, i.e. 12 volts or 42 volt, the preferred supply is the 42 volt supply.

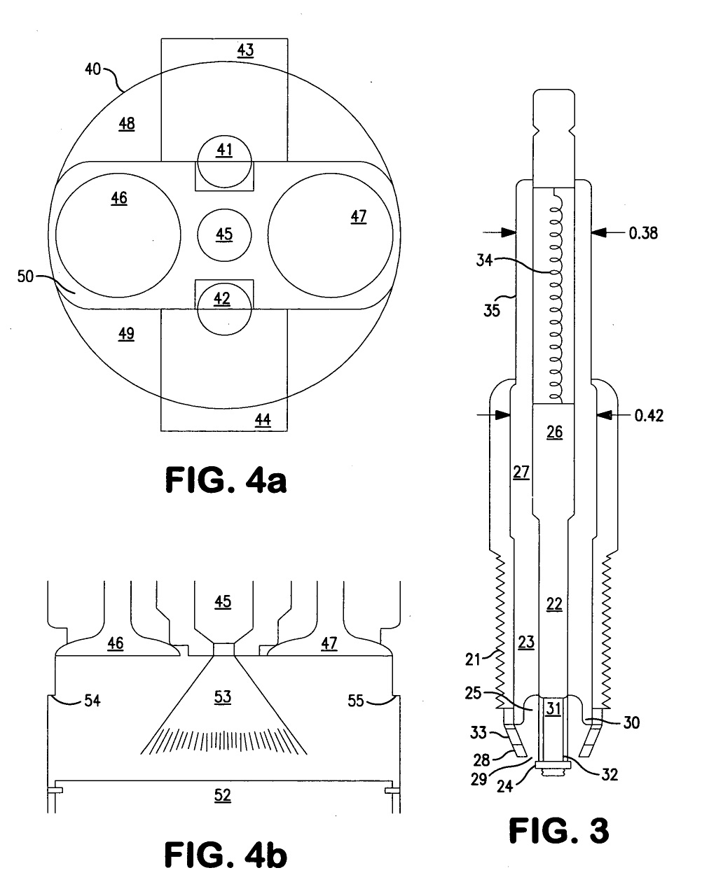

FIG. 3 is an approximately twice scale, side-view of a capacitive, halo-disc plug showing the cross-section of the plug but not showing the section with the four holes or slots. The plug has a slim-line body with a ⅝″ or 9/16″ hex and with a standard 14 mm thread, although a 12 mm thread could easily be accommodated without serious compromise of the design. The slim-line body also makes it easier to use two plugs per cylinder, and to be able to have them be oriented vertically. It is noted that the plug resembles the plugs of FIGS. 6a to 6f of my patent '513, and the figures and numbers may be used for description. But the FIGS. 6a to 6f will be referenced so as not to cause confusion.

Note that the spark plug is of the halo-disc type disclosed also in my U.S. Pat. No. 5,577,471 and '077, as well as '513, which is disclosed at one atmosphere and a spark gap of 0.070″ has a low breakdown voltage of approximately 7 kilovolts (kV), versus a standard J-type plug with a similar gap which has a breakdown voltage of approximately 10 kV. The spark plug has erosion resistant material at the electrode ends, such as Nickel-200 on the ground side, and tungsten-nickel-iron (W—Ni—Fe) on the HV tip 24, or other material such as platinum. Note that a very thin coating of catalyst type material may be placed on the outer section of the center conductor exposed to the combusting gases to enhance the lean combusting mixture.

The inner diameter (ID) of the portion along the 14 mm thread, 21, has a diameter of 0.360″ to 0.375″ and the center electrode 22 has an OD of 0.15″, leaving a ceramic (high purity alumina 23) thickness of 0.11″ to be able to hold off 42 kV. Note that if a 12 mm plug is used, one preferably uses a diameter of 0.36″ instead of 0.375″. Preferably, the center electrode 22 is copper for good cooling of the plug tip 24, and for having good HF electrical conductivity. The insulator 23 is good fitting on its ID and OD for better cooling of the tip 24 and for high capacitance. When the electrode 22 emerges from the ceramic concave end 25, it has a smaller diameter of 0.105″ with a threaded portion of 4-40 at the end. In turn, the 0.105″ has a tubular section of OD 0.135″ to cover and protect the high conductivity copper, e.g. nickel 200. The center conductor 26 is 0.20″ OD with ceramic portion 27 with ID 0.20″ and OD 0.42″, with overall plug capacitance of 25 pF to 60 pF.

The conical ground section 28 has an included angle θ of FIG. 6f of '513 about equal to 50°. The section 28 is approximately 0.15″ vertically, and the concave ceramic section 25 is also approximately 0.15″, making a hollow of approximately 0.30″ of the plug, with four holes 33 for the air to pass through, and during the intake to keep the plug end clean and cool. Typically, the firing end gap 29 is between 0.050″ and 0.070″, depending on the offset of the electrode 24 makes with the closest ground point, while other such gap separations are greater than 0.070″. Note that the concave end 30 is approximately equal to 0.045″ thick, making the separation between the center electrode 31/32 of OD 0.135″, with preferably a nickel layer 32, and the ceramic end 30 be 0.075″. The back end of the plug preferably contains an inductor suppressor 34, such as that disclosed in my patents U.S. Pat. Nos. 6,545,415 and 6,584,965. The typical plug is 3 inches long and is made of three parts: the threaded part and firing end, about one inch; the central capacitance portion of about inch; and the insulating end with suppressor, also about one inch. Note that the section 26 can be a non-resistor glass seal for sealing the central metallic conductor 26/22/31 to the ceramic section 23/27/35.

FIGS. 4a and 4b relate to using the Optimized Coils with preferably the halo-disc spark-plugs in two-stroke engines which tend to have higher residuals and need better ignition. The disclosures show preferably fuel injector means. In my U.S. Pat. No. 7,165,528 [referred to as '528, for short], in FIG. 3a, is shown a central fuel injector, in the context of a 4-stroke engine, with two spark plugs and two valves. In such designs, whether 2-stroke or 4-stroke, the operation is preferably very lean for better fuel efficiency, at AFR of 24 to 30 to 1, and at approximately stoichiometry [gasoline 14.7 AFR] for power.

FIG. 4a is an approximately to scale, top view drawing of a single cylinder 40, two-stroke uniflow-scavenged with two plugs 41 and 42 symmetrical placed with small, high energy density optimized coils 43 and 44 mounted on the plugs, and between the plugs and approximately located at the center of the head is fuel-injector means 45, and two vertically oriented valves 46 and 47, equally spaced about the center of the head. Preferably, two squish-flow lands are shown on the top 48 and bottom 49 halves of the cylinder 40, so that when the piston is near or at top center (TC) a channel 50 is formed. The squish clearance between the top of squish land and the piston is less than 0.1 inch at TC. The clearance [at TC] between the cylinder head and the piston in the region of the channel 50 is approximately 0.5 inch for a compression ratio (CR) of approximately 10 to 1, or approximately 0.4 inch for a CR of approximately 12 to 1. Clearly, the squish flow at the two plug sites is towards the center of the combustion chamber. For a thorough discussion, see my patent application '982.

FIG. 4b is an approximately to scale, side view drawing of a single cylinder of representative BORE [B] of 3.5″, and STROKE [S] of 3.0″, of a two-stroke uniflow-scavenged engine with two plugs with small, high energy density optimized coils mounted on the plugs, and between the plugs and approximately located at the center of the head is fuel-injector means 45 with two vertically oriented valves 46 and 47 equally spaced about the center of the head, with the piston 52 at about 120° before TC and the exhaust valves having just closed, and the fuel injector 53 spray giving the main fuel injection of the required fuel, which mixes with the mostly fresh air, to form a partial homogeneous mixture at TC (120° later). Like numerals refer to like parts with respect to FIG. 4a.

The fuel injector 45 can be made to operate also at the time of ignition, say about 30° BTC, to inject a small amount of fuel to help the spark ignition process, especially when an ultra lean mixture is used.

The air intake ports are near the bottom of the cylinder (and preferably across from each other, i.e. 180° apart) have reed valves or other type of one way check valves, so that the one-way valves prevent higher pressure exhaust gas from entering the intake ports and mixing with the fresh air.

In place of the poppet valves 46 and 47, rotary valves [one or two] can be substituted, and one can also have one-way valves near the bottom of the cylinder, which can be more easily controlled [e.g. Coates rotary valves].

Note that if fresh air enters the exhaust, this is not an efficiency robbing problem if the fuel injector has not yet been fired, and no fuel is wasted by entering the exhaust.

Note that since the exhaust valves close at approximately 120° BTC, a higher than normal CR e.g. 13 to 1, which may require slightly lager squish lands and/or less height [0.35″] at TC in the region of the channel [50], and a Miller cycle may ensue. This also insures that the engine cylinders are free-wheeling [not a problem here since both valves are exhaust valves].

Note that the exhaust valves can be electrically actuated, which allows variable valve closure which affects the effective CR.

While the cylinder head has preferably two valves, each being smaller and lighter than a single valve and permitting higher RPM [without the problem of valve float] and two large squish lands that form a channel near TC, and that it may be advantageous to have minor squish lands or squish zones 54 and 55 at the ends of the channel, as described in my patent '528.

An alternative design for the intake of the 2-stroke engine is to use the Gnome Rotary principle of having the intake valve located in the piston face.

The piston face valve system [called Uniflow/Gnome] has an opening duration of approximately 70° centered around bottom center [BC], i.e. opening at 135° BBC and 35° ABC.

The opening of the valve can be achieved a number of ways, notably by having the [bottom edge of] piston motion stopped, i.e. interrupted, near its end motion, at the required crank angle. The connecting rod will continue its motion and force the piston face valve to open for the time duration at which the piston's motion is interrupted.

The piston and crankcase will be designed so that the piston on its downward motion will act to compress the fresh air inside the piston above one atmosphere, which will, in turn, be forced through the piston face valve and begin to fill the intake, and the exhaust gas will empty through the valve(s) in the head of the Uniflow/Gnome system. The opening times of both the piston face valve [intake valve] and the exhaust valves are approximately equal.

In my U.S. Pat. No. 7,318,397, issued Jan. 15, 2008, referred to as '397, and in'528, are shown various ways to limit the peak pressure near TC from a high CR, say 13 to 1 to 10 to 1, by various spring methods, with a valve placed on the piston face. For example, taking FIG. 16 of '397, and having one or two steel or titanium disc springs below the valve, the springs can prevent the valve from moving beyond its normal resting place, except near TC at high pressure, when the springs can compress to reduce the pressure, the valve drops, as expected.

Usually, a 4-stroke, lean burn engine, is considered superior to a 2-stroke for emissions. In our case, we regularly noticed oil on the piston on our single cylinder, 4-stroke, lean burn engine, running part-load after a short time. The problem was alleviated when we held the oil level feeding the two valve stems at a low pressure, well below one atmosphere. It was concluded that the air intake on the intake stroke was below one atmosphere, and the oil contamination was caused by the pressure difference between the atmospheric pressure and the low intake pressure [the oil being sucked in the combustion chamber].

Using the uniflow scavenging engine with piston face valve [Uniflow/Gnome engine], then with proper design, the pressure in the combustion chamber, even at low loads, is always above one atmosphere. In fact, for this design, apparently the 2-stroke is actually cleaner that the 4-stroke [with successful part load, lean burn operation]. The requirement is to have a powerful ignition, e.g. as in FIGS. 4a and 4b, so that in some cases where the residual is high, the mixture may still be properly ignited. The main emission problem is unburnt hydrocarbons, not NOx, which can be best handled by having dual ignition of the Optimized Coil [of energy of at least 100 mj] and halo-disc plugs.

The problem of lubrication [e.g. the piston] is still a factor in the 2-stroke engine [the Uniflow/Gnome engine]. I suggest that for the valve in the piston face that the crank case be divided into two parts. the inner portion [ICC] defined by the interior of the piston with predominantly fresh air, and the outer portion [OCC] defined by the exterior of the piston containing oil for lubrication of the piston, etc. The ICC is about the same volume as the interior of the piston, the piston being divided into two sections, the piston volume being the Bore times the Skirt length [3 to 6 inches]. It can be assessed that being in the reciprocal compression stroke in terms of the fresh air in the bottom portion of the engine, which will be squeezed out to enter the intake as fresh air when the piston-valve opens. Note that the ICC volume can be defined as having part of the inner boundary be the inner part of the piston; while the OCC can be defined as having part of the outer boundary be the outer part to the piton [to lubricate the piston rings].

The piston face will be the separator element so that on the inside of the piston it handles air, see FIG. 6a of my patent '528 and FIG. 14 of my patent '397, and on the outside it handles lubrication. It can be viewed that the piston interior volume, Vpi, is compressed on the expansion stroke, i.e. CRX=Vd/Vpi, where Vd is the engine displacement. It is assured that the entire piston is kept within the entire cylinder, and the ends of the piston skirt has elastomer material for both sealing the piston against a portion of the rotating crank-like section and for taking part of the shock, when the piston engages with the crank. This insures that the fresh air in the piston is compressed to move at the piston valve opening to mostly fill the intake with air [and with small amount of residual, say between 15% and 45%].

Alternatively, FIG. 7 and FIG. 10 of my patent '397, and piston top 10 and 24 of FIG. 7 are made into a valve, and the volume is made smaller below the piston 10, FIG. 10, patent '397, then one can, in principle, have a two-stroke engine of the type disclosed with also the potential for the “operation in a high compression conversion exchange cycle”, my patent '397.

Other methods are available for keeping the fresh air separated from the oil, including using very small amount of oil on the outside of the piston. One wishes to have just enough oil to lubricate, without causing excessive friction. One can use Teflon and/or Torlon [high temperature, low friction, plastic material] buttons on the outside of the piston, requiring less lubricant.

Since certain changes may be made in the above apparatus and method, without departing from the scope of the invention herein disclosed, it is intended that all matter contained in the above description, or shown in the accompanying drawings, shall be interpreted in an illustrative and not limiting sense.

What is claimed is:

1. An inductive ignition system for an internal combustion system with one or more ignition coils and associated power switches Swi, with each coil having a primary winding of turns Np and inductance Lp, and a secondary high voltage winding for producing high voltage sparks of Ns turns and an inductance Ls, the primary and secondary winding defining a turns ratio Nt equal to Ns/Np, the coil having two large air gaps within their magnetic core at the end of the open-E core and containing two biasing magnets at the open end of the open-E core, the coil producing an energy Ep of 80 to 300 mJ or higher, and a peak secondary current Is of between 200 and 600 ma and the secondary winding with segmented bobbin and producing a high voltage of 25 kV to 50 kV, the improvement comprising coil structure means which have the following:
a) the coil primary turns Np between 60 and 140 turns making up two layers of wire having an inductance Lp between 600 uH and 1400 uH;
b) a coil turns ratio Nt is between 35 and 60;
c) and the magnetic energy needed to produce an optimized coil of bias magnet height “ht” that must be calculated according to the “Optimization Equation” which obeys the equation:
ht={½·11·[Bsat·Np]²·A³}/{ml·mw·Emagden·100·Lp}
where the bias magnet volume of one magnet is Vmag=ml·mw·ht, where V½=A·11 is the half core volume where A is the core area and 11 is the effective length of the core, and wherein Emag=Vmag·Emagden is the energy in one of the bias magnets and Emagden is the energy density of the bias magnets, where Ip is the maximum primary current which leads to the highest magnetic induction B equal to the saturation magnetic induction of the core material, e.g. 2 Tesla for SiFe, which is evaluated for the coil without the biasing magnets, equal to the coil primary energy Ep1=½*Lp*Ip1**2, and wherein the average coil energy Ep11=Emag/V_{1/2} mJ/coil, or Ep11=½*Lp*Ip11**2, which is equal to Ep1, to thus precisely optimize the operation on the coil, resulting in the optimized coil of energy Ep2 and current Ip2 which is four times the energy that an unbiased coil of maximum energy Ep1, i.e. where Ip2=2*Ip1, and Ep2=4*Ep1.

2. The ignition system of claim 1 wherein the primary wire is of 22 to 28 AWG, and the secondary winding has a wire gage between 36 and 42 AWG, and peak primary current Ip of 15 and 30 amps.

3. The ignition system of claim 1 wherein the power switch Swi comprises a 600 volt rating IGBT switch.

4. The ignition system of claim 1 wherein the voltage rating of the power supply that powers the coil is between 24 volts and 60 volts.

5. The ignition system of claim 1 wherein the coil output capacitance Cs is of a low value between 15 and 30 pF and the spark plug capacitance is 10 to 50 pF.

6. An inductive ignition system for an internal combustion system with one or more ignition coils and associated power switches Swi, with each coil having a primary winding of turns Np and inductance Lp, and a secondary high voltage winding for producing high voltage sparks of Ns turns and an inductance Ls, the primary and secondary winding defining a turns ratio Nt equal to Ns/Np, the coil having large air gaps at the two ends of the magnetic core, the first end of the core containing two biasing magnets, and the second open end containing ferrite or like magnetic material to form a closed core, the coil producing an energy Ep of 80 to 300 mJ or higher, and a peak secondary current Is of between 200 and 500 ma and the secondary winding with segmented bobbin and producing a high voltage of 25 kV to 50 kV, the improvement comprising coil structure means which have the following:
a) the coil primary turns Np between 60 and 140 turns making up two layers of wire having an inductance Lp between 600 uH and 1400 uH;
b) a coil turns ratio Nt is between 30 and 60;
c) and the magnetic energy needed to produce an optimized coil of bias magnet height “ht” that must be calculated according to the “Optimization Equation” which obeys the equation:
ht={½·11·[Bsat·Np]²·A³}/{ml·mw·Emagden·100·Lp}
where the bias magnet volume of one magnet is Vmag=ml·mw·ht, where V/½=A·11 is the half core volume where A is the core area and l1 is the effective length of the core, and wherein Emag=Vmag·Emagden is the energy in one of the bias magnets and Emagden is the energy density of the bias magnets, where Ip is the maximum primary current which leads to the highest magnetic induction B equal to the saturation magnetic induction of the core material, e.g. 2 Tesla for SiFe, which is evaluated for the coil without the biasing magnets, equal to the coil primary energy Ep1=½*Lp*Ip1**2, and wherein the average coil energy Ep11=Emag/V_{1/2} mJ/coil, or Ep11=½*Lp*Ip11**2, which is equal to Ep1, to thus precisely optimize the operation on the coil, resulting in the optimized coil of energy Ep2 and current Ip2 which is four times the energy that an unbiased coil of maximum energy Ep1, i.e. where Ip2=2*Ip1, and Ep2=4*Ep1.

7. The ignition system of claim 6 wherein the coil, also known as a pencil coil of cylindrical shape, is approximately one inch in diameter and between two and three inches in length, and has an energy density of approximately one mJ/gm or greater.

8. The ignition system of claim 6 wherein the two biasing magnets are essentially rectangular in shape, and whose length ml spans the inner and outer cores, whose width mw is equal to the diameter of the center core, and whose height “ht” is chosen to satisfy the Optimization Equation.

9. The ignition system of claim 6 wherein the second open end of the coil contains ferrite magnetic material to form a closed core with little fringing of the magnetic field, and the end of the ferrite material being next to the high voltage end.

10. An ignition system for a two-stroke uniflow-scavenged engine with two plugs located in the cylinder head which are symmetrical placed with small, high energy density optimized coils mounted on the plugs, and between the plugs and approximately located at the center of the head is fuel-injector means, and two vertically oriented valves, equally spaced about the center of the head. Preferably, two squish-flow lands are on the top and bottom halves of the cylinder, so that when the piston is near or at top center (TC) a channel is formed. The squish clearance between the top of squish land and the piston is less than 0.1 inch at TC. The clearance between the cylinder head and the piston in the region of the channel is approximately 0.5 inch, for a compression ratio (CR) of approximately 10 to 1. The squish flow at the two plug sites is towards the center of the combustion chamber.

11. The ignition system of claim 10 wherein the CR of the engine is approximately 13 to 1 and the clearance between the cylinder head and the piston in the region of the channel is approximately 0.4 inch.

12. The ignition system of claim 10 wherein the spark plugs are of the halo-disk type and have concave ceramic at the spark firing end, and the spark plug has erosion resistant material at the electrode ends, such as Nickel-200 on the ground side, and tungsten-nickel-iron (W—Ni—Fe) on the HV tip.

13. The ignition system of claim 10 wherein the spark plug's inner diameter (ID) of the portion along the 14 mm thread has a diameter of 0.360″ to 0.375″ and the center electrode has an OD of 0.15″ and wherein the spark plug's firing end has a spark gap of at least 0.050″.

14. The ignition system of claim 10 wherein the spark plug is approximately 3 inches long and is made of three parts: the threaded part and firing end, about one inch; the central capacitance portion of about inch; and the insulating end with suppressor, also about one inch. The central section can be a non-resistor glass seal for sealing the central metallic conductor to the ceramic section.

15. The ignition system of claim 10 wherein the fuel-injector means can be made to operate also at the time of ignition, say about 30° BTC, to inject a small amount of fuel to help the spark ignition process, especially when an ultra lean mixture is used.

16. The ignition system of claim 10 wherein the said piston has a valve in its face, the system called a Uniflow/Gnome system, the piston valve having an opening duration of approximately 70° centered around BC.

17. The ignition system of claim 16 wherein the opening of the valve can be achieved a number of ways, notably by having the bottom edge of piston motion stopped near its end motion, at the required crank angle. The connecting rod will continue its motion and force the piston face valve to open for the time duration at which the piston's motion is interrupted.

18. The ignition system of claim 16 wherein the piston and crankcase will be designed so that the piston on its downward motion will act to compress the fresh air inside the piston above one atmosphere, which will, in turn, be forced through the piston face valve and begin to fill the intake, and the exhaust gas will empty through the valve(s) in the head of the Uniflow/Gnome system. The opening times of both the piston face valve and the exhaust valves are approximately equal.

19. The ignition system of claim 16 wherein are shown various ways to limit the peak pressure near TC from a high CR, say 13 to 1 to 10 to 1 by having one or two steel or titanium disc springs below the valve, the springs can prevent the valve from moving beyond its normal resting place except near TC at high pressure, when the springs can compress to reduce the pressure, the valve drops, as expected.

20. The ignition system of claim 16 wherein lubrication of the piston is carried out by small amount oil in contact with the outside of the piston, wherein the inner portion ICC defined by the interior of the piston which contains predominantly fresh air, and the outer portion OCC defined by the exterior of the piston containing oil for lubrication of the piston. The ICC is about the same volume as the interior of the piston, the piston being divided into two sections, the piston volume being the Bore times the Skirt length [3 to 6 inches]. In the reciprocal compression stroke in terms of the fresh air in the bottom portion of the engine, which will be squeezed out to enter the intake as fresh air when the piston-valve opens, the ICC volume can be defined as having part of the inner boundary be the inner part of the piston; while the OCC can be defined as having part of the outer boundary be the outer part to the piton to lubricate the piston rings.
